(19) United States
(12) Patent Application Publication
(10) Pub. No.: US 2017/0328839 A1
(43) Pub. Date: Nov. 16, 2017

(54) Cosmetic Evaluation Box for Used Electronics

(71) Applicants: Tu Nguyen, Fremont, CA (US); Tien Trinh, Ho Chi Minh (VN)

(72) Inventors: Tu Nguyen, Fremont, CA (US); Tien Trinh, Ho Chi Minh (VN)

(73) Assignee: GDT, Inc., Fremont, CA (US)

(21) Appl. No.: 15/586,927

(22) Filed: May 4, 2017

Related U.S. Application Data
(63) Continuation of application No. 14/690,449, filed on Apr. 19, 2015, now abandoned.
(60) Provisional application No. 61/984,666, filed on Apr. 25, 2014.
(60) Provisional application No. 62/027,096, filed on Jul. 21, 2014.

(51) Int. Cl. G01N 21/88

(52) U.S. Cl. CPC G01N 21/8803; G01N 21/8851; G01N 21/8806; G01N 2021/8854; G01N 2021/8841

(57) ABSTRACT

A cosmetic testing device for electronic devices that uses the electronic device's own camera to take photographs of the electronic device in order to determine its cosmetic condition.

### CROSS-REFERENCE TO RELATED APPLICATIONS

The present application is a continuation of application Ser. No. 14/690,449, filed Apr. 19, 2015, which takes priority from Provisional Applications No. 61/984,666, filed Apr. 25, 2014, and No. 62/027,096, filed Jul. 21, 2014, which are herein incorporated by reference.

### BACKGROUND

Smartphones and other small electronic devices evolve rapidly, and thus are frequently upgraded by consumers. As a result, many consumers have one or more used electronic devices that they no longer need. Reselling those devices is often a hassle that does not justify the time or the expense of doing so.

In order to determine the value of a used electronic device, its functional capacity and its cosmetic condition need to be evaluated. While evaluating a device's functional capacity usually only requires some simple electronics, evaluating the device's cosmetic condition requires either a human eye (and humans are often biased and inconsistent) or expensive and complex camera systems. In situations where a used electronic device is being repurchased automatically, at a kiosk, for example, the only option being used at present is expensive and complex camera systems. Such camera systems are used to take photographs of the electronic device, and the photographs are then analyzed to determine the number, size, and location of any cosmetic imperfections of the electronic device. This data is then used to determine a cosmetic score for the electronic device and to provide an objective measure of its cosmetic condition.

While it is possible to use a camera system to evaluate an electronic device, it adds a lot of expense and complexity to the evaluation machine. Camera systems are not only expensive, they break and require repair; they require periodic maintenance; and the software needed to operate them is also complex and prone to breaking.

Most electronic devices of today, such as smartphones and tablets, typically comprise one or more cameras. The cameras on such devices are often quite sophisticated and the device comprises all the software needed to operate the camera. These electronic devices also comprise powerful processors that are easily capable of evaluating an image. Due to this fact, it is desirable to make it possible to use an electronic device's own camera and processor in performing the cosmetic evaluation of the electronic device.

A need therefore exists for a fixture that holds an electronic device in an appropriate position for using the electronic device's own camera or cameras to take photographs of the electronic device, and provides mirrors in the appropriate positions so that the electronic device's own camera or cameras can take photographs of the electronic device.

### SUMMARY OF THE INVENTION

An object of the present invention is to reduce the cost and complexity of cosmetic evaluation devices by utilizing an electronic device's own camera and processor in performing the cosmetic evaluation.

Another object of the present invention is to enable a test of an electronic device's cosmetic condition to be performed easily and cheaply.

For purposes of the present invention, an “electronic device” is a smartphone, tablet, or other small electronic device that comprises at least one camera and a processor.

The system of the present invention comprises an enclosure that contains at least one mirror and a device holder. The device holder securely holds an electronic device without obstructing any of its cameras. The mirror or mirrors are positioned in such a way as to reflect a view of the electronic device so that an image of the electronic device may be taken by one of its cameras. The enclosure also contains at least one light source, preferably a light panel of the type used in photography. The electronic device's own processor is used to trigger the electronic device to take photographs, to process those photographs to determine the cosmetic condition of the electronic device, and to transmit the analysis results to a server. The enclosure does not comprise any processor or memory of its own; the processor and memory of the electronic device are used for all the tasks requiring a processor and memory.

In an embodiment, the processor of the electronic device is further configured to disable the screen of the electronic device, cause it to display a solid color, or cause it to display a static image while it is taking a photograph using a front-facing camera.

In an embodiment, the analysis step comprises determining the number and type of cosmetic imperfections in a photograph and calculating a cosmetic score for the electronic device based on the number and type of cosmetic imperfections.

In an embodiment, the step of determining the number and type of cosmetic imperfections in a photograph comprises subtracting the photograph from a photograph of a similar electronic device in perfect condition to obtain a difference image, and determining the number of lines in the difference image. If a line does not extend to an edge, it is a scratch. If a line extends to an edge, it is a crack. If the area adjacent to the line comprises any white pixels, it is a crack affecting the LCD screen; if it does not, the line is a crack that does not affect the LCD screen.

The inside surfaces of the enclosure are preferably matte to prevent reflections.

In an embodiment, two mirrors are present in the enclosure; one is positioned so as to reflect an image of the electronic device into its front-facing camera, and one is positioned so as to reflect an image of the electronic device into its rear-facing camera.

In an embodiment, a third mirror is present in the enclosure as well, said third mirror positioned in such a way as to reflect an image of the left side, right side, top side, or bottom side of the electronic device into at least one camera.

Any of the mirrors may be repositioned.

In an embodiment, at least one mirror is at a distance from the electronic device that is equal to or greater than the minimal focal distance for the camera of the electronic device.

The device holder preferably comprises a top member and a bottom member, the top member coming in contact with the top of the device and the bottom member coming in contact with the bottom of the device. The inner surfaces of the top member and the bottom member are preferably soft and unable to scratch the device.

The enclosure preferably comprises at least one door, said door closed automatically or manually before the cosmetic test begins. In an embodiment, the light turns on automatically when the door is closed.

### LIST OF FIGURES

FIG. 1 shows a diagram of the preferred embodiment of the present invention.

FIG. 2 shows another view of the preferred embodiment of the present invention.

FIG. 3 shows a view of the outside of the enclosure of the preferred embodiment of the present invention.

### DETAILED DESCRIPTION OF THE PREFERRED EMBODIMENT

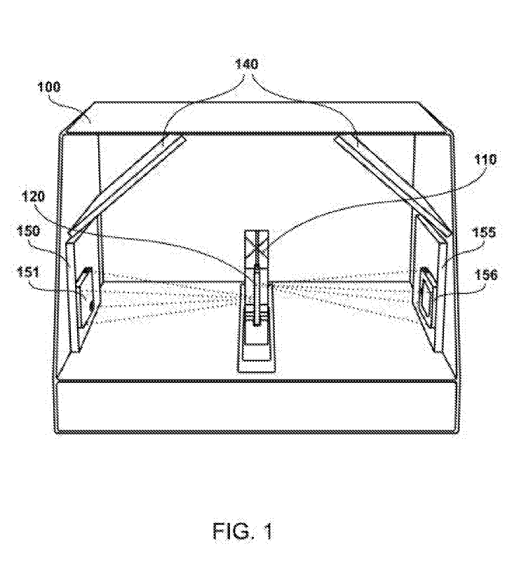

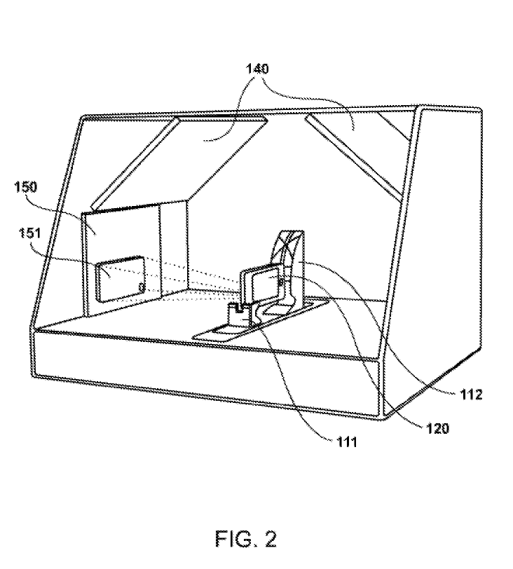

FIGS. 1 and 2 show the preferred embodiment of the present invention. It is preferably an enclosure 100 with a holder module 110 located approximately at the midpoint of the container. Holder module 110 is preferably sized and shaped in such a way as to hold a smartphone or other small electronic device 120 without obstructing the electronic device's cameras. In an embodiment, different-size holder modules may be used depending on what electronic device is tested; the enclosure 100 may have mounting hardware that allows different holder modules to be attached.

As can be seen in the Figures, the present invention does not comprise a camera of any kind or any other kind of imaging device. The only imaging device used for the present invention is the camera or cameras and the processor of the electronic device itself. This enables the present invention to be a lot cheaper than evaluation devices that use cameras and processors, and to require much less maintenance and repair.

While the advantage of the present invention is that the cosmetic testing fixture can be extremely simple and cheap—the only hardware inside the device of the present invention is a light fixture—one of the difficulties associated with the present invention is that each type of electronic device has a slightly different camera with slightly different parameters. The present invention, thus, also comprises an app to be installed on the device that can control the camera of that particular device to take a photo, use the processor and memory of the device to process the photo, and use the communication interface of the device to send the image to a server. While every device's camera is slightly different, all currently manufactured smartphones have a camera and processor capable of performing the tasks demanded by the app.

The holder module preferably comprises a front clip 111 and a rear clip 112, as shown in FIG. 2. The front clip and the rear clip are preferably flexible or soft in a way that enables the electronic device to be securely held between them. In the preferred embodiment, the inner surface of the front clip and the rear clip are also lined with a soft fabric that does not damage the finish of the electronic device.

The app of the present invention is preferably configured to cause the device to perform the following functions. First of all, it can trigger the device to take a picture, using both of its cameras. In the preferred embodiment, the app gives a user a 10-second countdown warning, to give the user enough time to place the device into the enclosure and shut the door. However, that is not required for practicing the present invention.

Once the photos are taken, the processor of the device analyzes the photo or photos. In the preferred embodiment, the processor looks for cracked glass or scratches in the photo, and makes the following determinations:

a. Broken glass

b. Broken LCD

c. Both of the above

d. None of the above:
i. Where are the scratches?
ii. How long are the scratches?
iii. On the screen or elsewhere? (Zone 1=screen; zone 2=elsewhere)

While many methods exist for performing this type of analysis, in the preferred embodiment, the algorithm of the present invention compares an image of an electronic device of the same make and model in perfect condition with the photo taken by the camera of the electronic device. Any differences between the two images are then analyzed to determine whether they are cracks or scratches, and if they're cracks, whether the crack extends to the LCD screen or is only affecting the glass. In the preferred embodiment, any imperfection that extends all the way to the edge of the device is perceived as a crack, while imperfections that do not extend all the way to the edge of the device are perceived as scratches. If a crack exists, the CPU then analyzes whether or not there are any LCD screen imperfections around the crack. If there are, the crack is logged as extending to the LCD screen.

While performing this analysis requires some computational resources, it will be noted that any smartphone manufactured within the past few years is capable of such computations. The app of the present invention can run on any smartphone or tablet of recent manufacture.

Light sources 140 are used to provide adequate lighting for any photos taken within the enclosure. In the preferred embodiment, the light sources are light panels such as typically used in photography, to provide uniform lighting for the electronic device. The light sources preferably emit white light; however, light of any other color may also be used. The light sources are positioned in such a way as to emit light onto the electronic device for an adequate photograph to be taken. In the preferred embodiment, as shown in FIGS. 1 and 2, the light sources 140 are located above the device. In the preferred embodiment, light sources 140 turn on automatically when the doors of the enclosure are closed.

Mirrors 150 and 155 are used to reflect the electronic device in such a way that a photograph of the electronic device may be taken with the electronic device's own camera. In the preferred embodiment, as shown in the Figure, two mirrors are used, one on each side of the electronic device. Mirror 150 is used to reflect an image of the electronic device 151 for the rear-facing camera to take a photograph of the device; mirror 155 is used to reflect an image of the electronic device 156 for the front-facing camera to take a photograph of the device.

The mirrors are preferably positioned in such a way as to “place” the image of the electronic device at the closest focal distance from the device's camera that is taking the photograph. Since every device's camera is slightly different, the mirrors may be positioned at the largest such distance, so that most of the devices placed in the enclosure will be accommodated.

The preferred embodiment, as shown, only enables two photos to be taken—a photo of the front and the rear sides of the electronic device. In other embodiments, multiple mirrors may be used to reflect other sides of the electronic device in such a way as to enable either the front-facing or the rear-facing camera of the electronic device to take photos of the left side, right side, top side, or bottom side of the electronic device. In an embodiment, mirrors may be moved or repositioned by the user in such a way as to reflect a particular side of the device. Mirrors may also be moved automatically by the system of the present invention to be in the proper position for photos to be taken of a particular side of the device.

On most electronic devices such as smartphones and tablets, the screen of the device shows an image of what is “seen” by the camera. When the front-facing camera on an electronic device is used to take a photo of the device itself in the mirror, the screen of the electronic device shows a recursive image of the device taking a picture of itself. This image may interfere with the cosmetic analysis of the electronic device, as scratches and other imperfections may be obscured. In an embodiment, the app disables the screen on the electronic device while the front-facing camera is used to take a photograph of the device. The screen of the electronic device may be turned off altogether, or may show a solid color such as white or blue, to highlight any imperfections on the device's screen.

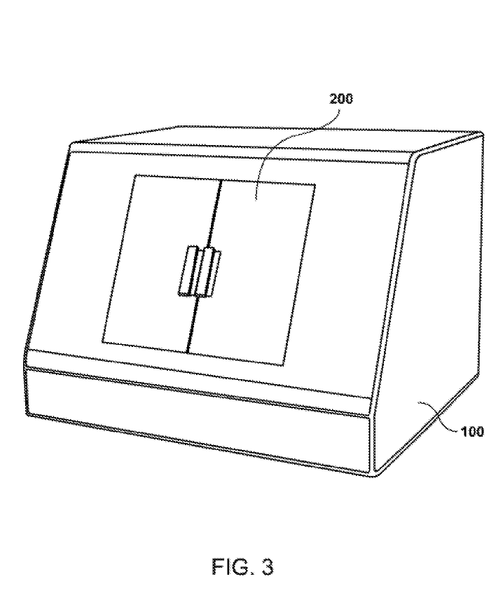

FIG. 3 shows an outer view of the system of the present invention. Doors 200 are sliding doors that close prior to the start of the testing process. This ensures that no external light gets into the testing area and allows the lighting to be more controlled for better photographs. The doors may comprise light-blocking foam or other features that prevent any light from getting inside the enclosure while the doors are closed. As mentioned above, the lights 140 may turn on automatically when the doors 200 are closed.

The inner surface of the enclosure may be painted or finished in such a way as to minimize unwanted light reflections and to improve the photographs taken of the electronic device. In the preferred embodiment, the inner surface is matte white.

Exemplary embodiments have been described above. It will be understood that the invention encompasses other embodiments and that the only limitations on the scope of the present invention are expressed in the appended claims.

1. A cosmetic testing fixture for an electronic device, said electronic device comprising at least one camera and a processor, said electronic device capable of communicating with a server, said cosmetic testing fixture comprising:
an enclosure;
a device holder, said device holder mounted inside the enclosure, said device holder capable of securely holding an electronic device without obstructing any of its cameras;
at least one mirror, said mirror located in such a way as to reflect an image of the electronic device so that it is within the view of the at least one camera of the electronic device;
at least one light fixture, said light fixture located within the enclosure in such a way as to provide adequate lighting for the at least one camera of the electronic device to take a photograph of the image of the electronic device;
wherein the processor of the electronic device is configured to:
trigger the at least one camera to take at least one photograph;
perform an analysis of the at least one photograph to
determine the cosmetic condition of the electronic device;
transmit a result of the analysis to a server;
wherein the cosmetic testing fixture does not comprise a camera or a processor.

2. The cosmetic testing fixture of claim 1, wherein the processor of the electronic device is further configured to perform one of the following actions:
disable the screen of the electronic device while it is taking a photograph using a front-facing camera;
cause the screen of the electronic device to display a solid color while it is taking a photograph using a front-facing camera;
cause the screen of the electronic device to display a static image while it is taking a photograph using a front-facing camera.

3. The cosmetic testing fixture of claim 1, wherein the step of performing an analysis comprises:
process at least one photograph to determine the number and type of cosmetic imperfections shown in the photograph;
calculate a cosmetic score for the electronic device based on the number and type of cosmetic imperfections.

4. The cosmetic testing fixture of claim 3, wherein the step of processing the at least one photograph comprises:
subtracting the at least one photograph from a photograph of an electronic device of the same make and model in perfect condition to obtain a difference image, wherein any identical pixels are displayed as black and any different pixels are displayed as white;
determining the number of lines present in the difference image;
for each line, determining if it extends to an edge of the electronic device;
for each line, determining if an area immediately adjacent to the line comprises any white pixels;
if a line does not extend to the edge of the electronic device on either end, concluding the line is a scratch;
if the area immediately adjacent to the line comprises any white pixels, and the line extends to the edge of the electronic device on at least one end, concluding the line is a crack and it extends to the LCD screen;
if the area immediately adjacent to the line does not comprise any white pixels, and the line extends to the edge of the electronic device on at least one end, concluding the line is a crack and it does not extend to the LCD screen.

5. The cosmetic testing fixture of claim 1, where the inner surface of the enclosure is matte.

6. The cosmetic testing fixture of claim 1, comprising a first mirror, said first mirror being positioned in such a way as to reflect an image of the electronic device into a front-facing camera of the electronic device when the electronic device is in the device holder, and a second mirror, said second mirror being positioned in such a way as to reflect an image of the electronic device into a rear-facing camera of the electronic device when the electronic device is in the device holder.

7. The cosmetic testing fixture of claim 6, further comprising a third mirror, said third mirror being positioned in such a way as to reflect an image of the left side, right side, top side, or bottom side of the electronic device into at least one camera of the electronic device.

8. The cosmetic testing fixture of claim 7, wherein at least one of the first mirror, second mirror, and third mirror may be repositioned.

9. The cosmetic testing fixture of claim 1, wherein the at least one mirror is at a distance from the electronic device that is equal to or greater than the minimal focal distance for the camera of the electronic device.

10. The cosmetic testing fixture of claim 1, wherein the enclosure comprises at least one door.

11. The cosmetic testing fixture of claim 1, wherein the device holder comprises:
a top member, said top member in contact with the top of the electronic device when the electronic device is in the device holder;
a bottom member, said bottom member in contact with the bottom of the electronic device;
the top member and the bottom member being situated in such a way as to provide sufficient pressure onto the top and bottom of the electronic device to securely hold it in the device holder.

12. The cosmetic testing fixture of claim 9, wherein at least one of the top member and the bottom member comprises a soft fabric on the surface that contacts the electronic device.

13. The cosmetic testing fixture of claim 1, wherein the at least one light fixture is a light panel.

14. The cosmetic testing fixture of claim 10, wherein the at least one light fixture turns on automatically when the at least one door is closed.
